(19) United States
(12) Patent Application Publication
(10) Pub. No.: US 2025/0376231 A1
(43) Pub. Date: Dec. 11, 2025

(54) Motorcycle Rear Fender Cap

(71) Applicants: Jeremy Harman, Greer, SC (US); Monica Harman, Greer, SC (US)

(72) Inventors: Jeremy Harman, Greer, SC (US); Monica Harman, Greer, SC (US)

(21) Appl. No.: 18/739,236

(22) Filed: Jun. 10, 2024

(51) Int. Cl. B62J 17/00; B62J 6/04

(52) U.S. Cl. CPC B62J 17/00; B62J 6/04

(57) ABSTRACT

To provide a motorcycle rear fender cap to prevent mud and debris from entering the body cavity of the motorcycle by covering the openings in the motorcycle body cavity when the rear motorcycle light assembly is modified. Motorcycles having rear taillight assemblies are typically sealed to prevent mud and debris from entering the body cavity of the motorcycle but many motorcycle owners choose to modify or remove the rear taillight assembly to customize the motorcycle. The motorcycle rear fender cap mounts to the rear chassis of the motorcycle and covers the openings when a rear motorcycle light assembly is modified, covering unsightly openings and preventing mud and debris from entering the motorcycle cavity.

### BACKGROUND OF THE INVENTION

Motorcycles having rear taillight assemblies are typically sealed to prevent mud and debris from entering the body cavity of the motorcycle. However, many motorcycle owners choose to modify the rear taillight assembly to customize the motorcycle. Reasons for modifications include installing different lights for ornamental reasons, or to replace original equipment light assemblies with less expensive ones. Other reasons for modification include replacing the rear light assembly to reduce the motorcycle's size or weight for riding the motorcycle offroad. Often these modifications result in openings that are unsightly and allow mud or debris to enter the body cavity of the motorcycle. Mud and debris entering the body cavity of the motorcycle creates a problem because critical components, such as the engine air intake and electrical components, are typically located within the body cavity and can become damaged from the mud and debris.

### SUMMARY OF THE INVENTION

The present invention solves the foregoing problem of having an unsightly opening on the body of the motorcycle when the rear motorcycle light assembly is modified. The invention also prevents mud and debris from entering the body cavity of the motorcycle by covering the openings in the motorcycle body cavity when the rear motorcycle light assembly is modified or replaced.

The present invention comprises of a motorcycle rear fender cap that covers the openings in the motorcycle body cavity created when the rear motorcycle light assembly is modified or replaced. Changing the original rear light assembly to a smaller or different version often results in unwanted openings in the body cavity. The present invention mounts to the rear chassis of the motorcycle and covers the openings around the new or modified light assembly, preventing mud and debris from entering the motorcycle cavity.

Motorcycles are operated in various climates and extreme weather conditions. The present invention is comprised of a synthetic material that is heat, UV, water, and impact resistant. Due to the application and exposure to various environmental elements, the motorcycle rear fender cap is made to withstand relevant conditions.

The present invention is mounted to the rear chassis of the motorcycle using mounting holes that allow the rear fender cap to be bolted to the chassis of the motorcycle. A mounting bracket with holes can be used with the present invention to accommodate various mounting configurations. Often the existing holes in the motorcycle chassis used to mount the taillight assembly can be used to mount the rear fender cap. Holes can also be drilled into the motorcycle chassis to mount the rear fender cap.

### BRIEF DESCRIPTION OF DRAWINGS

FIG. 1 depicts a front left perspective view of the motorcycle rear fender cap used to cover the openings around the motorcycle light assembly when the rear motorcycle light assembly is modified or replaced.

FIG. 2 depicts a bottom view of the design of FIG. 1.

FIG. 3 depicts a top view of the design of FIG. 1.

FIG. 4 depicts a back view of the design of FIG. 1.

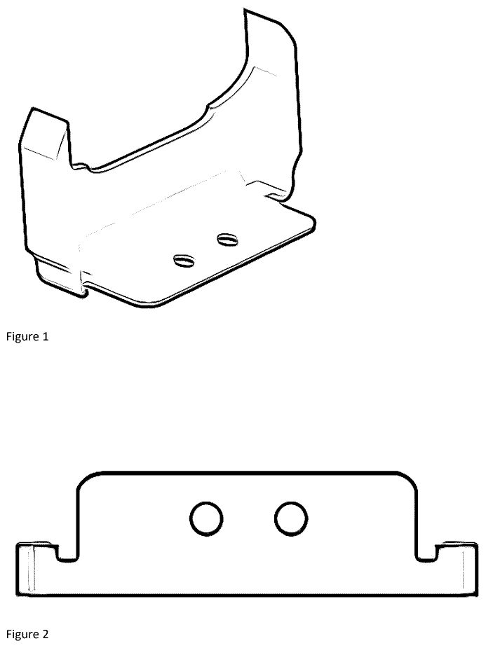

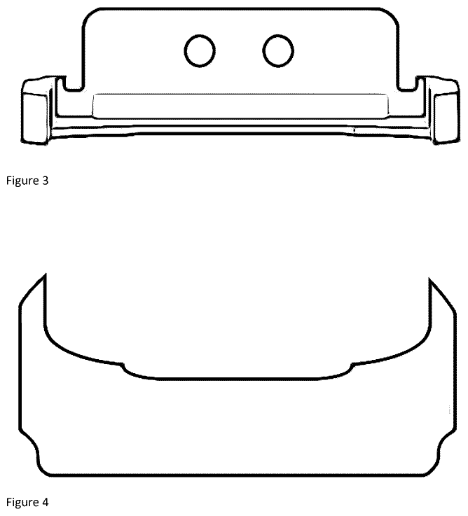

### DETAILED DESCRIPTION OF THE INVENTION

The present invention mounts to the rear chassis of the motorcycle and covers the openings when a rear motorcycle light assembly is modified, preventing mud and debris from entering the motorcycle cavity.

As shown in FIG. 1, the motorcycle rear fender cap has mounting holes in the bottom mounting plate allowing it to be fastened to the underneath side of the rear chassis of the motorcycle. As shown in FIG. 1 and FIG. 4, the motorcycle rear fender cap wraps around the motorcycle light assembly covering openings that allow dirt and debris to enter the chassis of the motorcycle.

1. A motorcycle rear fender cap mounted to the rear chassis of a motorcycle, comprising;
a cover to seal the openings resulting from modifications to the rear light assembly.

2. The motorcycle rear fender cap as in claim 1, wherein said cover is made of a weatherproof synthetic material that is heat, UV, water, and impact resistant.

3. A method of mounting the motorcycle rear fender cap comprising of;
attaching the motorcycle rear fender cap to the rear chassis of the motorcycle using existing mounting holes on the motorcycle.

4. A method of mounting the motorcycle rear fender cap comprising of;
attaching the motorcycle rear fender cap to the rear chassis of the motorcycle by drilling new mounting holes in the motorcycle.
